(19) United States
(12) Patent Application Publication
(10) Pub. No.: US 2022/0196908 A1
(43) Pub. Date: Jun. 23, 2022

(54) OPTICAL FIBER AND OPTICAL FIBER FILTER

(71) Applicants: SUMITOMO ELECTRIC INDUSTRIES, LTD., Osaka (JP); Sumitomo Electric Optifrontier Co., Ltd., Yokohama-shi (JP)

(72) Inventors: Shigehiro NAGANO, Osaka (JP); Takemi HASEGAWA, Osaka (JP); Masakazu SHIGEHARA, Osaka (JP); Masayuki YAMAZAKI, Yokohama-shi (JP)

(21) Appl. No.: 17/557,216

(22) Filed: Dec. 21, 2021

(30) Foreign Application Priority Data
Dec. 23, 2020 (JP) 2020-214109

(51) Int. Cl. G02B 6/02

(52) U.S. Cl. CPC G02B 6/02395

(57) ABSTRACT

An optical fiber includes a silica-based glass. The optical fiber includes a core, an optical cladding surrounding the core, and a physical cladding surrounding the optical cladding. The optical cladding includes a first region in contact with the core and surrounding the core. A photosensitive material is added to the core and the first region. A concentration of the photosensitive material in the first region is 30% or more of a concentration of the photosensitive material in the core. A value obtained by integrating a light intensity of an LP₀₁ mode at a wavelength of 1310 nm in a region added with the photosensitive material is 87% or more of a value obtained by integrating the light intensity in an entire region of the optical fiber.

### TECHNICAL FIELD

The present disclosure relates to an optical fiber and an optical fiber filter.

The present application claims priority from Japanese Patent Application No. 2020-214109 filed on Dec. 23, 2020, which is based on the contents and all of which are incorporated herein by reference in their entirety.

### BACKGROUND

An optical fiber grating is utilized as a monitoring filter for performing wavelength selection termination in a passive optical network (PON) system. The optical fiber grating used for the purpose is called a terminal fiber grating (TFG). In order to enable even larger capacity transmission, it is preferable to reflect only the wavelength band of about ±5 nm centered on the monitoring wavelength 1650 nm band and to enable transmission in wavelengths other than the wavelength band, for example, a C band (1530 nm or more and 1565 nm or less) and an L band (1565 nm or more and 1625 nm or less).

WO2019/177114 discloses an optical fiber grating capable of reliably reflecting light in a wavelength band of about 1650 nm and suppressing transmission loss in a wavelength band of about 1520 nm. In the optical fiber grating, a refractive index distribution shape is a single peak type having an exponent a in order to reduce a change in refractive index in a radial direction of the optical fiber minus a change in propagation mode at a boundary portion between a core and a cladding.

### SUMMARY

An optical fiber according to an aspect of the present disclosure includes a silica-based glass. The optical fiber includes a core, an optical cladding surrounding the core, and a physical cladding surrounding the optical cladding. The optical cladding includes a first region in contact with the core and surrounding the core. A photosensitive material is added to the core and the first region. A concentration of the photosensitive material in the first region is 30% or more of a concentration of the photosensitive material in the core. A value obtained by integrating a light intensity of an LP₀₁ mode at a wavelength of 1310 nm in a region added with the photosensitive material is 87% or more of a value obtained by integrating the light intensity in an entire region of the optical fiber.

An optical fiber filter according to an aspect of the present disclosure is an optical fiber filter being provided with periodic refractive index modulation formed along a longitudinal direction in the core of the optical fiber.

### BRIEF DESCRIPTION OF THE DRAWINGS

FIG. 1 is a diagram illustrating transmission characteristics of an optical fiber grating according to a comparative example.

FIG. 2 is a partially enlarged view of FIG. 1.

FIG. 3 is a diagram illustrating a refractive index distribution of an optical fiber according to a first embodiment together with a dopant concentration and a light intensity of an LP₀₁ mode.

FIG. 4 is a diagram illustrating transmission characteristics of the optical fiber grating according to the first embodiment.

FIG. 5 is a diagram illustrating a refractive index distribution of an optical fiber according to a second embodiment together with the dopant concentration and the light intensity in the LP₀₁ mode.

FIG. 6 is a diagram illustrating a refractive index distribution of an optical fiber according to a third embodiment together with the dopant concentration and the light intensity of the LP₀₁ mode.

FIG. 7 is a diagram illustrating a refractive index distribution of an optical fiber according to a fourth embodiment together with the dopant concentration and the light intensity of the LP₀₁ mode.

FIG. 8 is a diagram illustrating a refractive index distribution of an optical fiber according to a fifth embodiment together with the dopant concentration and the light intensity of the LP₀₁ mode.

### DETAILED DESCRIPTION

### Problem to be Solved by Present Disclosure

The optical fiber grating disclosed in WO2019/177114 is insufficient in reducing transmission loss in an L band.

Therefore, a purpose of the present disclosure is to provide an optical fiber and an optical fiber grating capable of reliably reflecting light in a wavelength band of about 1650 nm and further reducing transmission loss of an L band.

### Effect of Present Disclosure

The present disclosure provides an optical fiber and an optical fiber filter capable of reliably reflecting light in a wavelength band of about 1650 nm and further reducing transmission loss of an L band.

### Description of Embodiments of Present Disclosure

First, embodiments of the present disclosure will be listed and described. An optical fiber according to an aspect of the present disclosure includes a silica-based glass. The optical fiber includes a core, an optical cladding surrounding the core, and a physical cladding surrounding the optical cladding. The optical cladding includes a first region in contact with the core and surrounding the core. A photosensitive material is added to the core and the first region. A concentration of the photosensitive material in the first region is 30% or more of a concentration of the photosensitive material in the core. A value obtained by integrating a light intensity of an LP₀₁ mode at a wavelength of 1310 nm in a region added with the photosensitive material is 87% or more of a value obtained by integrating the light intensity in an entire region of the optical fiber.

In the optical fiber according to the aspect of the present disclosure, a ratio at which the light in the LP₀₁ mode at a wavelength of 1310 nm and the region added with the photosensitive material overlap is high. For the reason, in the optical fiber grating manufactured from the optical fiber, it is possible to reliably reflect the light in a wavelength band of about 1650 nm, and it is possible to further reduce the transmission loss of the L band.

The optical cladding further includes a second region surrounding the first region, and a refractive index of the first region may be equal to or higher than a refractive index of the second region. In this case, a trench structure can be formed by the second region.

A ratio d₁/d_{CO} of an outer diameter d₁ of the first region to an outer diameter d_{CO} of the core may be 1.5 or more and 3.0 or less. In this case, the first region in which the refractive index increases with ultraviolet irradiation increases, and flatness of the refractive index distribution in the fiber cross section collapses, and thus, transmission characteristics with respect to the wavelength are deteriorated, so that it is possible to avoid the increase in manufacturing cost.

A ratio d_{CL}/d_{CO} of an outer diameter d_{CL} of the optical cladding to the outer diameter d_{CO} of the core may be 2.5 or more and 4.5 or less. In this case, it is possible to suppress a ratio of portions manufactured internally such as MCVD and PCVD.

The photosensitive material may be GeO₂.

A relative refractive index difference between the core and the first region may be 0.36% or more and less than 0.41%.

The core may contain fluorine. In this case, the degree of freedom in the amount of the photosensitive material added to the core can be increased.

An fluorine concentration in the core may be an amount reducing a relative refractive index by 0.01% or more. In this case, the amount of Ge added to the core can be increased by 0.01% or more in terms of a relative refractive index.

The core may have a step index type refractive index distribution shape. In this case, it is advantageous for coupling with the SMF.

An optical fiber filter according to an aspect of the present disclosure is an optical fiber filter being provided with periodic refractive index modulation formed along a longitudinal direction in the core of the optical fiber.

Since the optical fiber of the present disclosure is used in the optical fiber filter according to the above-described aspect, it is possible to reliably reflect the light in a wavelength band of about 1650 nm, and it is possible to further reduce the transmission loss of the L band.

### Details of Embodiments of Present Disclosure

Specific examples of an optical fiber of the present disclosure will be described below with reference to the drawings. It is noted that the present invention is not limited to these examples, and is indicated by the scope of claims, and is intended to include all modifications within the meaning and scope equivalent to the scope of the claims. In the description of the drawings, the same components are denoted by the same reference numerals, and duplicate description is omitted.

Methods for manufacturing an optical fiber grating as the optical fiber filter are disclosed in, for example, JP2003-004926A and JPH11-119041A. By irradiating the optical fiber made of a silica-based glass of which one or both of a core and a cladding contains the photosensitive material with ultraviolet light having a specific wavelength capable of increasing the refractive index, the refractive index of the silica-based glass containing the photosensitive material can be increased. As the ultraviolet light having a specific wavelength, for example, a double wave (wavelength 244 nm) of the argon ion laser light is used. As a method for writing the refractive index-modulated grating in the predetermined period inside the optical fiber, there are exemplified exposure with ±1st-order diffracted light using a grating phase mask, direct exposure with UV laser light, and two-luminous flux interference exposure. Among these methods, the method using the phase mask has an advantage that it is possible to produce the optical fiber grating having the same characteristics with good reproducibility and alignment is relatively easy as compared with other methods.

A representative refractive index profile of the optical fiber used in the manufacture of the fiber grating is the step index. The photosensitive material is added only to the core, thus, periodic refraction index modulation is performed only to the core. GeO₂ is a typical photosensitive material (refer to, for example, Junji Nishii, et al., “Ultraviolet-radiation-induced chemical reactions through one- and two-photon absorption process in GeO₂—SiO₂ glasses”, OPTICS LETTERS, Vol. 20, No. 10, May 15, 1995, pp. 1184-1186).

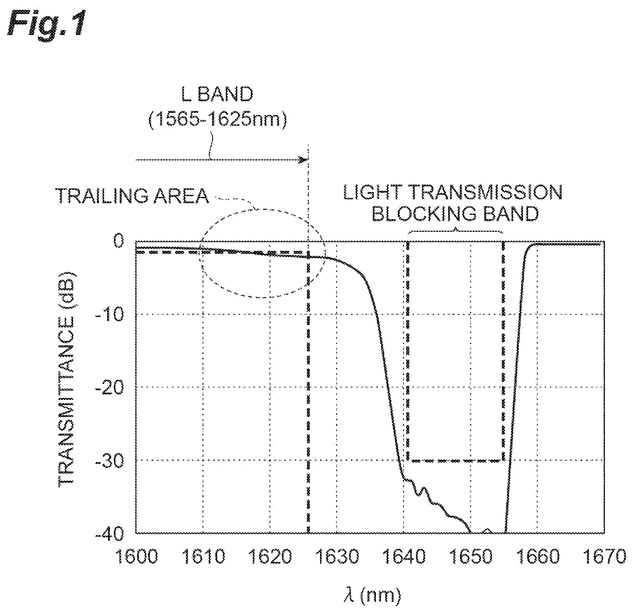

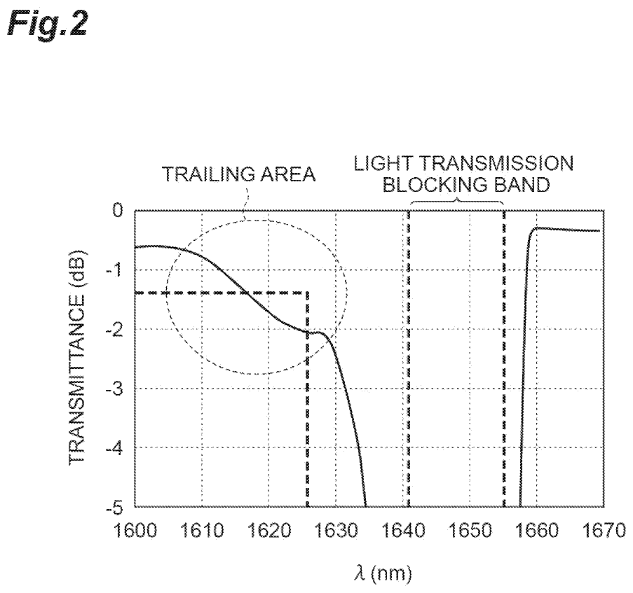

FIG. 1 is a diagram illustrating transmission characteristics of an optical fiber grating according to a comparative example. FIG. 2 is a partially enlarged view of FIG. 1. The horizontal axis of FIGS. 1 and 2 indicates a wavelength λ (nm), and the vertical axis indicates a transmittance (dB). In FIG. 2, the vertical axis is enlarged. The optical fiber grating according to the comparative example includes a core having a step index type refractive index distribution and a cladding surrounding the core. A photosensitive material is added only to the core, and periodic index modulation is formed only in the core. A wavelength of a light transmission blocking band is 1640 nm or more and 1655 nm or less. A transmittance represented in units of decibel required for the light transmission blocking band is −30.0 dB or less.

Although the optical fiber grating according to the comparative example can form the desired reflection in the wavelength band for monitoring, it has a characteristic that trailing phenomena of the transmission loss occurs on the short wavelength side in a region where the transmittance is reduced. Therefore, in the vicinity of a long wavelength end (1625 nm) of the L band, the loss of the optical fiber grating is so large that it cannot be ignored. In order to realize the large capacity communication in the L band, it is necessary to allow the transmittance in the 1625 nm band to be larger than −1.0 dB. In the comparative example, the reason why such trailing phenomena of the transmission loss occurs is that there are the cross section in which the refractive index is increased only in the core and the cross section in which the refractive index is not changed in the longitudinal direction of the region where the grating is formed, and the LP₀₁ modes (base modes) in these cross sections are different in shape.

In order to suppress the transmission loss, it is necessary to allow the light intensity distributions in the LP₀₁ modes to be equal between the region where the grating is formed and the region where the grating is not formed. For this purpose, it is necessary to form the grating in the entire region where the light of the LP₀₁ mode propagates, that is, in the entire region where the light intensity of the LP₀₁ mode exists in the cross section of the fiber.

In the optical fiber grating disclosed in WO2019/177114, the photosensitive material is added not only to the core but also to the inner cladding adjacent to the core. However, the concentration of the photosensitive material in the inner cladding is lower than the concentration of the photosensitive material in the core. Therefore, the increase in the refractive index of the inner cladding due to UV irradiation is smaller than the increase in the refractive index of the core. As the result, the refractive index difference between the core and the cladding is different between the cross section in which the refractive index is increased and the cross section in which the refractive index is not changed in the longitudinal direction of the region where the grating is formed. Therefore, in order to suppress the transmission loss, it is also necessary to allow the concentrations of the photosensitive materials to be equal between the inner cladding and the core.

### First Embodiment

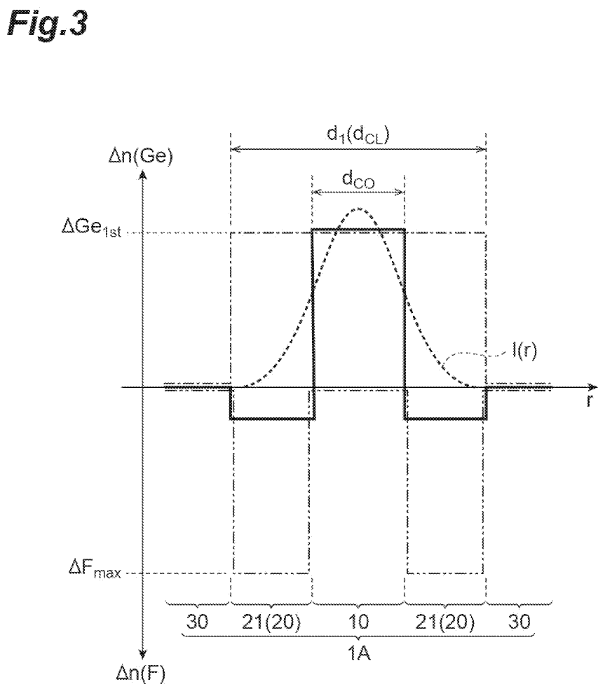

FIG. 3 is a diagram illustrating a refractive index distribution of an optical fiber 1A according to a first embodiment together with a dopant concentration and a light intensity in an LP₀₁ mode. The horizontal axis of FIG. 3 indicates the radial position of the optical fiber 1A. The vertical axis of FIG. 3 illustrates the relative refractive index of the optical fiber 1A. The relative refractive index of the optical fiber 1A is a refractive index standardized based on a refractive index of pure silica.

As illustrated in FIG. 3, the optical fiber 1A includes a core 10, an optical cladding 20 surrounding the core 10, and a physical cladding 30 surrounding the optical cladding 20. The core 10 in the optical fiber 1A has a step index type refractive index distribution shape. The optical fiber 1A is made of a silica-based glass.

The optical cladding 20 has a ring-shaped first region 21 surrounding the core 10. In the embodiment, the entire optical cladding 20 is configured with the first region 21. The first region 21 is provided in contact with the outer peripheral surface of the core 10. The first region 21 is adjacent to the core 10. In the embodiment, the outer diameter d₁ of the first region 21 is equal to the outer diameter d_{CL} of the optical cladding 20. The ratio d_{CL}/d_{CO} of the outer diameter d_{CL} to the outer diameter d_{CO} of the core 10 is 2.5 or more and 4.5 or less.

The physical cladding 30 is provided in contact with the outer peripheral surface of the optical cladding 20. The physical cladding 30 is adjacent to the optical cladding 20. For example, the physical cladding 30 does substantially not contain impurities. The impurity concentration in the physical cladding 30 is 10 ppm or less.

The core 10 and the first region 21 are added with a photosensitive material. That is, the core 10 and the first region 21 contain the photosensitive material. Examples of the photosensitive material include Ge and B, which are added as GeO₂ and B₂O₃. In the embodiment, the photosensitive material is Ge. The first region 21 is further added with fluorine. That is, the first region 21 further contains fluorine. The core 10 is not added with fluorine. FIG. 3 illustrates the Ge concentration and the fluorine concentration in the optical fiber 1A in terms of a relative refractive index. In FIG. 3, the Ge concentration is indicated by a one-dot dashed line, and the fluorine concentration is indicated by a two-dot dashed line.

The concentration of the photosensitive material in the first region 21 is 30% or more of the concentration of the photosensitive material in the core 10. In the embodiment, the Ge concentration in the first region 21 is equivalent to the Ge concentration in the core 10 and is ΔGe₁ₛₜ in terms of a relative refractive index. Therefore, the Ge concentration in the first region 21 is 100% of the Ge concentration in the core 10. Since the first region 21 contains fluorine, the relative refractive index of the first region 21 is lower than the relative refractive index of the core 10. The relative refractive index difference between the core 10 and the first region 21 (that is, the relative refractive index of the core 10 minus the relative refractive index of the first region 21) is 0.36% or more and less than 0.41%. The relative refractive index of the core 10 is, for example, 0.37% or more and less than 0.46%. The relative refractive index of the first region 21 is, for example, higher than −0.05% and −0.01% or less.

ΔFₘₐₓ that is the fluorine concentration in the first region 21 in terms of a relative refractive index is larger than ΔGe₁ₛₜ as compared in the absolute value. Therefore, the refractive index of the first region 21 is lower than the refractive index of the physical cladding 30. As described above, in the optical fiber 1A, since the fluorine concentration in the first region 21 is higher than the fluorine concentration required to cancel Ge, a step index type refractive index distribution with a trench structure can be realized. The trench width (diametrical thickness of the trench) is equal to the width of the first region 21 (diametrical thickness of the first region 21). The trench width is 5 μm or more and 10 μm or less. The step index type refractive index profile is advantageous for coupling with the SMF and can suppress the connection loss. In addition, it is possible to avoid difficulty in controlling the cutoff wavelength (λc). According to the trench structure, the bending loss resistance is improved.

In FIG. 3, the light intensity I(r) of the LP₀₁ mode at a wavelength of 1310 nm is illustrated by a broken line. A value V1 obtained by integrating the light intensity I(r) in the region added with the photosensitive material is 87% or more of a value V2 obtained by integrating the light intensity I(r) in the entire region of the optical fiber 1A. In the embodiment, V1 is 99% or more of V2. That is, the integrated value of the light intensity I(r) is 99% or more of the whole only in the Ge addition region. A ratio V of V1 and V2 is expressed by the following equation.

V=V1/V2=∫_{Region containing Ge}I(r)rdr/∫_{Entire region}I(r)rdr×100[%]

Since the photosensitive material is added to the core 10 and the first region 21, V1 is equal to the value obtained by integrating the light intensity I(r) in the core 10 and the first region 21. More specifically, V1 is equal to the value obtained by integrating the light intensity I(r) in the radial region where the radial position is in a range of −d1≤r≤d1. The ratio V indicates the ratio at which the LP₀₁ mode region and the region to which the photosensitive material is added (photosensitive region) overlap.

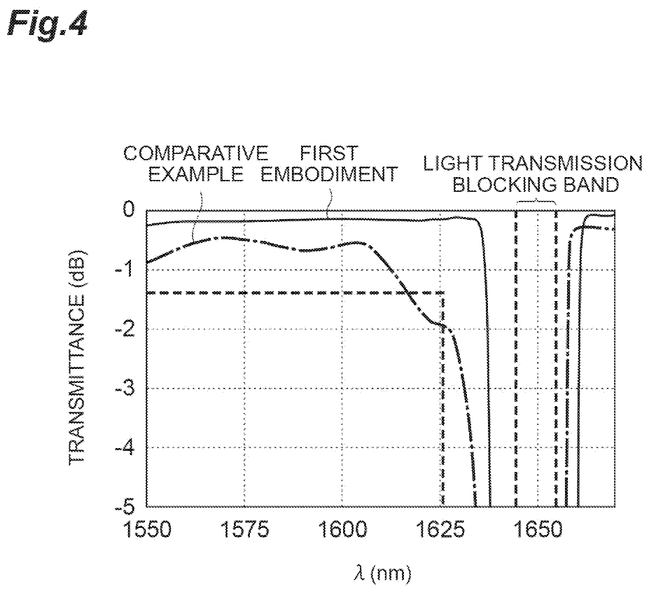

FIG. 4 is a diagram illustrating the transmission characteristics of the optical fiber grating according to the first embodiment. In FIG. 4, for comparison, the transmission characteristics of the optical fiber grating according to the comparative example are illustrated by a one-dot dashed line. In the optical fiber grating according to the first embodiment, periodic refractive index modulation is formed along the longitudinal direction in the core 10 and the optical cladding 20 of the optical fiber 1A. The period of the refractive index modulation may change continuously in the longitudinal direction.

As illustrated in FIG. 4, the transmittance of the optical fiber grating according to the first embodiment rises sharply from the light transmission blocking band (1640 nm or more and 1655 nm or less) toward the 1630 nm band, and the transmittance in the wavelength band of 1625 nm or less (at least 1550 nm or more) increases to −0.2 dB or more.

From the results of FIG. 4, in order to reduce the loss and to flatten the loss in the band of 1625 nm or less, it is necessary and extremely effective to increase the ratio V and allow the addition amount of the photosensitive material to be uniform in the photosensitive region. In the above comparative example, since the ratio V is 86%, it is important that the ratio V exceeds 87%. In the step index type optical fiber 1A, in order for the ratio V to exceed 87%, it is necessary to add Ge also around the core 10.

In order to allow the addition amount of the photosensitive material to be uniform in the photosensitive region, when the maximum value of the addition amount of the photosensitive material is denoted by ΔGe₁ₛₜ, it is effective to set the minimum value to be ΔGe₁ₛₜ×30% or more, it is more effective to set the minimum value to be ΔGe₁ₛₜ×60% or more, and it is most effective to set the minimum value to be ΔGe₁ₛₜ×80% or more. In the first embodiment, the minimum value is ΔGe₁ₛₜ×99% or more.

As described above, in the optical fiber 1A, the value V is 87% or more, and the ratio at which the light in the LP₀₁ mode at a wavelength of 1310 nm and the region added with the photosensitive material overlap is high. For this reason, in the optical fiber grating manufactured from the optical fiber 1A, it is possible to reliably reflect the light in a wavelength band of about 1650 nm, and it is possible to further reduce the transmission loss of the L band. In the optical fiber 1A, the transmittance in the 1625 nm band can be made larger than −1.0 dB while maintaining the mode field diameter (MFD) and λc within the design range.

In the optical fiber 1A, the relative refractive index difference between the core 10 and the first region 21 is adjusted to 0.36% or more and less than 0.41%.

### Second Embodiment

Next, an optical fiber 1B according to a second embodiment will be described focusing on the differences from the optical fiber 1A (refer to FIG. 3).

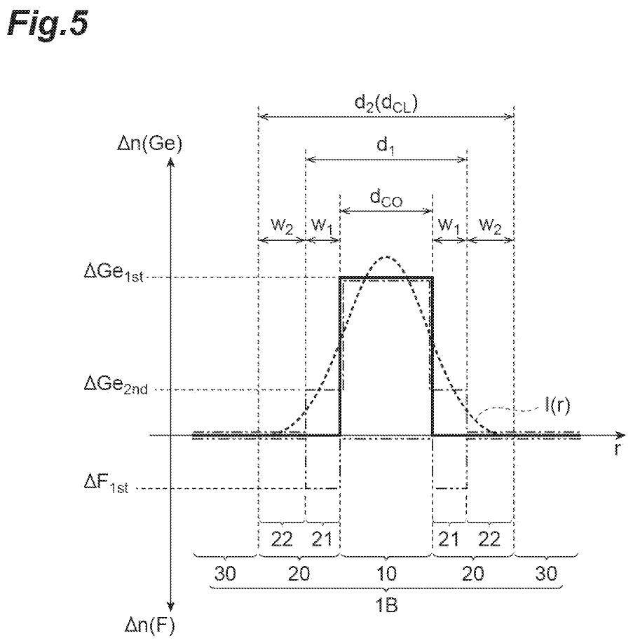

FIG. 5 is a diagram illustrating a refractive index distribution of the optical fiber 1B according to the second embodiment together with the dopant concentration and the light intensity in the LP₀₁ mode. As illustrated in FIG. 5, the optical fiber 1B has a step index type refractive index distribution shape to which the trench structure is not provided. In the optical fiber 1B, the optical cladding 20 further includes a ring-shaped second region 22 surrounding the first region 21. Ge as the photosensitive material is added to the first region 21, whereas no photosensitive material is added to the second region 22. That is, the second region 22 does not contain the photosensitive material. The concentration of the photosensitive material in the second region 22 is 0.01% or less in terms of a relative refractive index.

The ratio d_{CL}/d_{CO} of the outer diameter d_{CL} to the outer diameter d_{CO} is 2.5 or more and 4.5 or less. The ratio d_{CL}/d_{CO} of 3.0 or more and 4.0 or less is more effective.

In the embodiment, the ratio d₁/d_{CO} of the outer diameter d₁ to the outer diameter d_{CO} is 1.5 or more and 3.0 or less. The outer diameter d2 of the second region 22 is equal to the outer diameter d_{CL}.

In the second embodiment, the refractive index of the first region 21 is equivalent to the refractive index of the second region 22. The refractive index of the second region 22 is equivalent to the refractive index of the physical cladding 30. In the first region 21, Ge is added as ΔGe_{2nd} in terms of a relative refractive index. ΔGe₁ₛₜ is the maximum value of the amount of the photosensitive material added in the photosensitive region, and ΔGe_{2nd} is the minimum value of the amount of the photosensitive material added in the photosensitive region. ΔGe_{2nd} is effectively ΔGe₁ₛₜ×30% or more, more effectively ΔGe₁ₛₜ×60% or more, and most effectively ΔGe₁ₛₜ×80% or more. ΔGe_{2nd} is the addition amount that sufficiently functions as photosensitivity, and is, for example, 0.15% or more (ΔGe_{2nd}≥0.15%).

In the first region 21, fluorine is added as ΔF₁ₛₜ in terms of a relative refractive index. Since ΔGe_{2nd} and ΔF₁ₛₜ are equivalent to each other as compared in absolute value, ΔGe_{2nd} and ΔF₁ₛₜ cancel each other out. Therefore, the relative refractive index of the first region 21 is equivalent to the relative refractive index of the second region 22 and the relative refractive index of the physical cladding 30. Accordingly, in the optical fiber 1B, a step index type refractive index distribution can be realized. As mentioned above, the step index type refractive index profile is advantageous for coupling with the SMF. In addition, it is possible to avoid difficulty in controlling λc. If fluorine is not added to the first region 21, a ring-shaped region having a relative refractive index ΔGe_{2nd} is present with a width w₁ around the core 10, it is difficult to control λc.

Also in the optical fiber 1B according to the second embodiment, the value V1 is 87% or more of the value V2. For this reason, also in the optical fiber grating manufactured from the optical fiber 1B, it is possible to reliably reflect the light in a wavelength band of about 1650 nm, and it is possible to reduce the transmission loss in the L band. Since the optical fiber 1B is not provided with the trench structure, it is possible to reduce the manufacturing cost for the trench structure. For example, when the product length is short and it is not necessary to consider bending loss, the optical fiber 1B is effective.

### Third Embodiment

Next, an optical fiber 1C according to a third embodiment will be described focusing on the differences from the optical fiber 1B (refer to FIG. 5) according to the second embodiment.

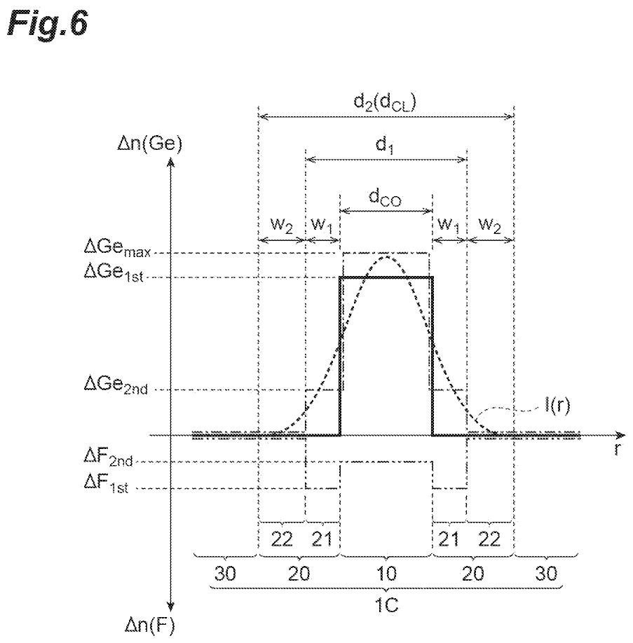

FIG. 6 is a diagram illustrating a refractive index distribution of the optical fiber 1C according to the third embodiment together with the dopant concentration and the light intensity in the LP₀₁ mode. As illustrated in FIG. 6, in the optical fiber 1C, the Ge concentration in the core 10 is higher than the Ge concentration in the core 10 in the optical fiber 1B, and is ΔGeₘₐₓ in terms of a relative refractive index. In the optical fiber 1C, the core 10 contains fluorine so that the core 10 has a desired relative refractive index ΔGe₁ₛₜ. The fluorine concentration in the core 10 is ΔF_{2nd} in terms of a relative refractive index. That is, the difference in absolute value between ΔGeₘₐₓ and ΔF_{2nd} is ΔGe₁ₛₜ. ΔF_{2nd} is, for example, −0.05% or more and −0.01% or less.

In order to set the transmittance of light in a wavelength band of about 1650 nm to −25 dB or less, it is effective to set ΔGeₘₐₓ to 0.41% or more. ΔF_{2nd} is adjusted so that the relative refractive index of the core 10 is in a range of 0.36% or more and less than 0.41%. For example, when ΔGeₘₐₓ=0.41%, ΔF_{2nd} is −0.05% or more and −0.01% or less.

Also in the optical fiber 1C, the value V1 is 87% or more of the value V2. For this reason, also in the optical fiber grating manufactured from the optical fiber 1C, it is possible to reliably reflect the light in a wavelength band of about 1650 nm, and it is possible to reduce the transmission loss in the L band.

Unlike the optical fiber 1C, in the optical fibers 1A and 1B, fluorine is not added to the core 10. Therefore, ΔGe₁ₛₜ that is the Ge addition amount to the pure silica in terms of a relative refractive index directly contributes to the relative refractive index of the core 10. In order to maintain the MFD and the λc within the design ranges, the relative refractive index of the core 10 cannot be increased at random. Therefore, in the optical fibers 1A and 1B, the degree of freedom with respect to the amount of Ge added in the core 10 is low. In contrast, in the optical fiber 1C, since fluorine is added to the core 10, it is possible to reduce the fiber manufacturing cost while increasing the degree of freedom in the amount of Ge added.

In the optical fiber 1C, ΔF_{2nd} is −0.05% or more and −0.01% or less. Therefore, the amount of Ge added to the core 10 can be increased by the amount corresponding to ΔF_{2nd}. Since the optical fiber 1C is not provided with the trench structure as in the optical fiber 1B, it is possible to reduce the manufacturing cost for the trench structure. Also in the optical fiber 1C, the ratio d₁/d_{CO} is 1.5 or more and 3.0 or less. The ratio d_{CL}/d_{CO} of the outer diameter d_{CL} to the outer diameter d_{CO} is 2.5 or more and 4.5 or less.

### Fourth Embodiment

Next, an optical fiber 1D according to a fourth embodiment will be described focusing on differences from the optical fiber 1C (refer to FIG. 6) according to the third embodiment.

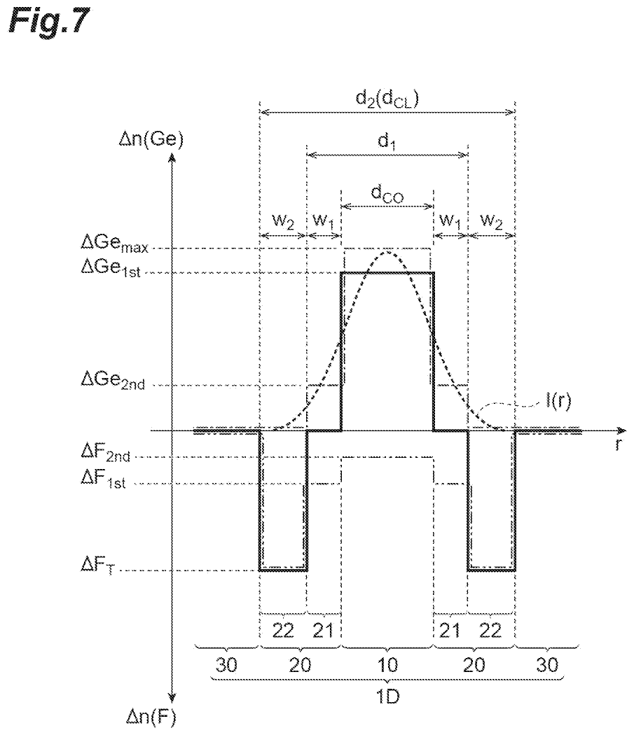

FIG. 7 is a diagram illustrating a refractive index distribution of the optical fiber 1D according to the fourth embodiment together with the dopant concentration and the light intensity in the LP₀₁ mode. As illustrated in FIG. 7, in the optical fiber 1D, the second region 22 contains fluorine. The fluorine concentration in the second region 22 is ΔF_{T} in terms of a relative refractive index. Accordingly, the refractive index of the second region 22 is lower than the refractive index of the first region 21 and the refractive index of the physical cladding 30. ΔF_{T} is, for example, −0.40% or more and −0.20% or less. In the optical fiber 1D, since fluorine is added to the second region 22 in this manner, a step index type refractive index distribution with a trench structure can be realized. A width w₂ of the second region 22 is the trench width. The trench width is 3.0 μm or more and 5.5 μm or less.

Also in the optical fiber 1D, the value V1 is 87% or more of the value V2. For this reason, also in the optical fiber grating manufactured from the optical fiber 1D, it is possible to reliably reflect the light in a wavelength band of about 1650 nm, and it is possible to reduce the transmission loss in the L band. Since the core of the optical fiber 1D has a step index type refractive index distribution, the connection with the SMF and the optical characteristics are good. Since the optical fiber 1D has a trench structure, the bending loss resistance can be improved. Also in the optical fiber 1D, the ratio d₁/d_{CO} is 1.5 or more and 3.0 or less. The ratio d_{CL}/d_{CO} of the outer diameter d_{CL} to the outer diameter d_{CO} is 2.5 or more and 4.5 or less.

### Fifth Embodiment

Next, an optical fiber 1E according to a fifth embodiment will be described focusing on the differences from the optical fiber 1D (refer to FIG. 7) according to the fourth embodiment.

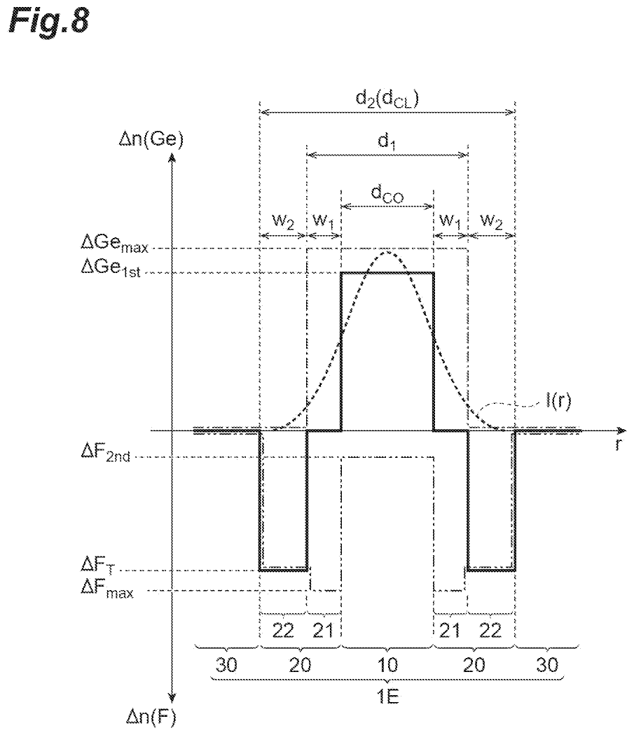

FIG. 8 is a diagram illustrating a refractive index distribution of the optical fiber 1E according to the fifth embodiment together with the dopant concentration and the intensity in the LP₀₁ mode. As illustrated in FIG. 8, in the optical fiber 1E, the first region 21 contains Ge equivalent to the core 10. That is, the Ge concentration in the first region 21 is equivalent to the Ge concentration in the core 10 and is ΔGeₘₐₓ in terms of a relative refractive index. In this manner, Ge is added to the core 10 and the first region 21 so that increases in refractive index are equal to each other, and the Ge concentration distribution is flattened in the core 10 and the first region 21. For example, when the relative refractive index of the core 10 is 0.41%, the relative refractive index of the first region 21 is also 0.41%.

In the first region 21, fluorine is added by ΔFₘₐₓ in terms of a relative refractive index. Since ΔGeₘₐₓ and ΔFₘₐₓ are equivalent to each other as compared in absolute value, ΔGeₘₐₓ and ΔFₘₐₓ cancel each other out. Therefore, the relative refractive index of the first region 21 is equivalent to the relative refractive index of the physical cladding 30. In the optical fiber 1E, since the second region 22 contains fluorine as in the optical fiber 1D, a step index type refractive index distribution with a trench structure can be realized. The fluorine concentration in the first region 21 is higher than the fluorine concentration in the second region 22, and ΔFₘₐₓ<ΔF_{T}.

Also in the optical fiber 1E, the value V is 87% or more. For this reason, also in the optical fiber grating manufactured from the optical fiber 1E, it is possible to reliably reflect the light in a wavelength band of about 1650 nm, and it is possible to reduce the transmission loss in the L band. Since the optical fiber 1E has a step index type refractive index distribution, the connection with the SMF and the optical characteristics are good. Since the optical fiber 1E has a trench structure, the bending loss resistance can be improved. Even in the optical fiber 1E, the ratio d₁/d_{CO} is 1.5 or more and 3.0 or less. The ratio d_{CL}/d_{CO} of the outer diameter d_{CL} to the outer diameter d_{CO} is 2.5 or more and 4.5 or less.

In each of the embodiments described above, the refractive index distribution of the core is a step index type, but the present invention is not limited thereto and may be, for example, a single peak type. When the refractive index distribution of the core is not a step index type, a position where the value obtained by differentiating the refractive index n(r), which is a function of a radius, with the radius is the smallest is defined as a boundary between the core 10 and the optical cladding 20.

What is claimed is:

1. An optical fiber including a silica-based glass, comprising:
a core;
an optical cladding surrounding the core; and
a physical cladding surrounding the optical cladding,
wherein the optical cladding includes a first region in contact with the core and surrounding the core,
wherein a photosensitive material is added to the core and the first region,
wherein a concentration of the photosensitive material in the first region is 30% or more of a concentration of the photosensitive material in the core, and
wherein a value obtained by integrating a light intensity of an LP₀₁ mode at a wavelength of 1310 nm in a region added with the photosensitive material is 87% or more of a value obtained by integrating the light intensity in an entire region of the optical fiber.

2. The optical fiber according to claim 1,
wherein the optical cladding further includes a second region surrounding the first region, and
wherein a refractive index of the first region is equal to or higher than a refractive index of the second region.

3. The optical fiber according to claim 2, wherein a ratio d₁/d_{CO} of an outer diameter d₁ of the first region to an outer diameter d_{CO} of the core is 1.5 or more and 3.0 or less.

4. The optical fiber according to claim 1, wherein a ratio d_{CL}/d_{CO} of an outer diameter d_{CL} of the optical cladding to an outer diameter d_{CO} of the core is 2.5 or more and 4.5 or less.

5. The optical fiber according to claim 1, wherein the photosensitive material is GeO₂.

6. The optical fiber according to claim 1, wherein a relative refractive index difference between the core and the first region is 0.36% or more and less than 0.41%.

7. The optical fiber according to claim 1, wherein the core contains fluorine.

8. The optical fiber according to claim 7, wherein a fluorine concentration in the core is an amount reducing a relative refractive index by 0.01% or more.

9. The optical fiber according to claim 1, wherein the core has a step index type refractive index distribution shape.

10. An optical fiber filter being provided with periodic refractive index modulation formed along a longitudinal direction in the core of the optical fiber according to claim 1.
